(19) United States
(12) Patent Application Publication
(10) Pub. No.: US 2014/0334825 A1
(43) Pub. Date: Nov. 13, 2014

(54) PROTOCOLS FOR CODED LIGHT COMMUNICATIONS

(71) Applicant: KONINKLIJKE PHILIPS N.V., EINDHOVEN (NL)

(72) Inventors: Ashish Vijay Pandharipande, Eindhoven (NL); Hongming Yang, Eindhoven (NL)

(21) Appl. No.: 14/362,151

(22) PCT Filed: Dec. 4, 2012
(86) PCT No.: PCT/IB12/56951

§ 371 Date: Jun. 2, 2014

Related U.S. Application Data
(60) Provisional application No. 61/567,209, filed on Dec. 6, 2011.

(51) Int. Cl. H04B 10/116; H04W 74/08

(52) U.S. Cl. CPC H04B 10/116; H04W 74/0816; H04B 10/40
USPC 398/128

(57) ABSTRACT

Protocols for coded light communication and control in a lighting system wherein each lighting device transmits modulated light during illumination are proposed. When a first source lighting device need to transmit information across the lighting system to a destination lighting device one or more intermediate lighting devices decode received coded light transmissions from the first source lighting device. The one or more intermediate lighting devices superimposes the coded light transmissions from the first source lighting device with coded light transmissions from a second source lighting device in a broadcast. The first source lighting device uses the received broadcast signal from the one or more intermediate lighting devices to retrieve the coded light transmissions from the second source lighting device by canceling stored a priori known signal components.

### FIELD OF THE INVENTION

The invention relates to the field of coded light systems, a lighting device for receiving and emitting coded light, a method related thereto.

### BACKGROUND OF THE INVENTION

Visible light has drawn recent interest as a new means of communication with recent developments in solid-state lighting that make it easier to accurately control light characteristics. Modulating visible light from luminaires such that information is embedded into the emitted light illumination while remaining imperceptible to users has recently been advocated. This concept is also called coded light communications. As disclosed in “Illumination sensing in LED lighting systems based on frequency division multiplexing,” by H. Yang, et al., IEEE Trans on Signal Processing, pp. 4269-4281, 2009, “Code division based sensing of illumination contributions in solid-state lighting systems,” by J.-P. Linnartz, et al., IEEE Trans on Signal Processing, pp. 3984-3998, 2009, different forms of modulation and access schemes, such as FDMA, CDMA and amplitude modulation based packet transmission have been proposed to achieve this.

For multiple access in such modulated lighting systems, protocols like CSMA are being considered. This in turn has an implication on lighting control in limiting use to asynchronous types of control protocols. The IEEE standards body is currently developing the physical and medium access control layer specifications for communications using visible light under IEEE 802.15.7. To allow for a low cost driver implementation, the fundamental frequency of visible light communication is commonly restricted to be around 2 kHz, although it, according to the IEEE 802.15.7 standard is allowed to be higher. This in turn limits the data rate that can be supported on a visible light communication link between two lighting devices maximally to the order of a few kbps, which in turn limits the network throughput. This limited data rate turns may be insufficient for real-time control applications when lighting devices need to share much more than a few bytes of control information.

### SUMMARY OF THE INVENTION

A number of disadvantages of the cited art has been identified in light of the present invention. For example, the network throughput of a lighting system is restricted by the data rate of the point-to-point link and the channel access protocol. As noted above, the data rate of a point-to-point link in a modulated lighting system is limited to a few kbps. This also limits the total network throughput under the use of CSMA/CA protocols.

In view of the above, an objective of the invention is to solve or at least reduce the problems discussed above. It is an objective of the present invention to propose protocols for visible light communications and control so that network throughput is improved and which facilitates a (pseudo-) synchronous lighting control. It is a particular objective of this invention to propose protocols for increasing the network throughput of a modulated lighting system so as to enable (real-time) exchange of high rate control information. Generally, the above objectives are achieved by the attached patent claims.

Proposed therefore are protocols for coded light communication and control in a lighting system wherein each lighting device transmits modulated light during illumination. In the proposed protocols, certain lighting devices need to exchange control information across the lighting system. In an embodiment of the proposed protocols, certain intermediate lighting devices decode received transmissions from lighting devices, digitally linearly encode the received signals and broadcast the superposed modulated light. In another embodiment of the proposed protocols, certain intermediate lighting devices trigger concurrent modulated light illumination from lighting devices. In either protocol, lighting devices use the received light signal from the intermediate lighting devices to retrieve the signal of interest by canceling stored a priori known signal components.

According to a first aspect of the present invention there is provided a lighting device for receiving and emitting coded light, comprising: a light detector arranged to receive light and in the received light detect coded light; a light decoder arranged to, in the received coded light, identify at least a first incoming coded light message and a second incoming coded light message embedded in the received light, the first coded light message originating from a first external lighting device and the second coded light message originating from a second external lighting device; a light driver arranged to form an outgoing coded light message, the outgoing coded light message being a combination of the first incoming coded light message and the second incoming coded light message; and a light emitter arranged to emit coded light comprising the outgoing coded light message.

Advantageously such a lighting device enables increased network throughput and permits support of high rate control information exchange across the lighting system. Compared to the classical CSMA/CA protocol the throughput can be increased significantly. The improvement generally depends on the system topology. For a system configuration with three lighting devices in a series configuration, the throughput can increase by ˜33% to ˜50%.

Each one of the first coded light message and the second coded light message may comprise a beacon message, respectively, where each beacon message comprises a source address and a destination address. The light decoder may further be arranged to extract the destination address from each one of the first coded light message and the second coded light message, to check in a database of addresses whether the lighting device is able to communicate with the destination address or not, and to form a response message comprising an acknowledgement thereof only in case the lighting device is able to communicate with the destination address, and the light emitter may further be arranged to emit coded light comprising the response message. Such a beacon message and/or response message may optimize the information throughput of the lighting system by identifying the shortest and/or fastest communications path from the lighting device of the source address to the lighting device of the destination address.

The lighting device may further comprise a memory. At least one of the first incoming coded light message and the second incoming coded light message may represent a first composite coded light message and a second composite coded light message, respectively. The light decoder may be arranged to in the at least one of the first composite coded light message and the second composite coded light message identify at least two individual coded light messages. The messages may be identified by comparing the at least one of the first composite coded light message and the second composite coded light message to at least one stored coded light message stored in the memory. Received messages may thus be compared to stored a priori information, thereby enabling extraction of unknown information by cancelling the stored a priori information from the received composite message. This advantageously allows decoding of individual messages originating from several emitting light sources from one observation of received coded light.

According to a second aspect of the present invention there is provided a coded light system comprising a lighting device, a first external lighting device and a second external lighting device as herein described.

According to a third aspect of the present invention there is provided a method for in a lighting device receiving and emitting coded light, comprising: receiving, by a light detector of the lighting device, light and in the received light detect coded light; identify in the received coded light, by a light decoder of the lighting device, a first incoming coded light message and a second incoming coded light message embedded in the received light, the first coded light message originating from a first external lighting device and the second coded light message originating from a second external lighting device; forming, by a light driver of the lighting device, an outgoing coded light message, the outgoing coded light message being a combination of the first incoming coded light message and the second incoming coded light message; and emitting, by a light emitter of the lighting device, coded light comprising the outgoing coded light message.

These and other aspect of the invention will be apparent from and elucidated with reference to the embodiments described hereinafter. The advantages and embodiments of the first aspect equally apply to the second and third aspects, respectively, and vice versa.

Generally, all terms used in the claims are to be interpreted according to their ordinary meaning in the technical field, unless explicitly defined otherwise herein. All references to “a/an/the/said [element, device, component, means, step, etc]” are to be interpreted openly as referring to at least one instance of said element, device, component, means, step, etc., unless explicitly stated otherwise. The steps of any method disclosed herein do not have to be performed in the exact order disclosed, unless explicitly stated.

### BRIEF DESCRIPTION OF THE DRAWINGS

Other features and advantages of the present invention will become apparent from the following detailed description of a presently preferred embodiment, with reference to the accompanying drawings, in which:

FIG. 1 illustrates a lighting systems according to prior art;

FIGS. 2a-d illustrate lighting systems according to embodiments;

FIG. 3 illustrates a lighting device according to embodiments;

FIG. 4a-d shows experimental performance results for lighting systems according to embodiments; and

FIG. 5 shows a flowchart for a method according to embodiments.

### DETAILED DESCRIPTION OF EMBODIMENTS

The present invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout.

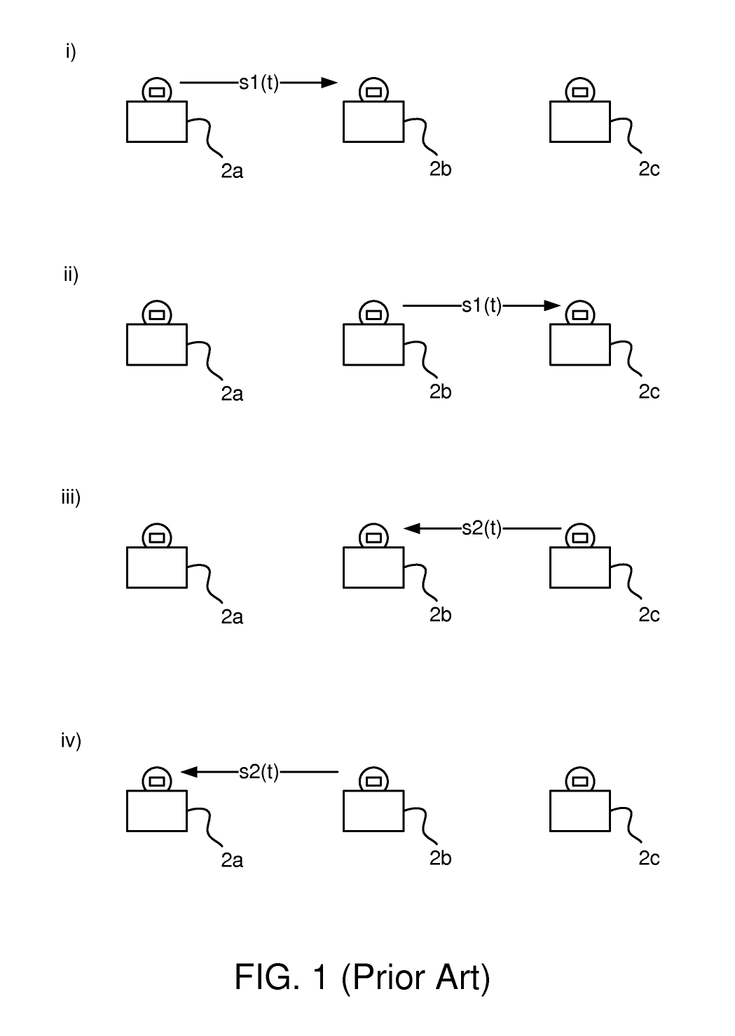

Consider the prior art lighting system according to FIG. 1. The lighting system includes three lighting devices 2a, 2b, 2c. The lighting devices 2a, 2b, 2c are within sensing range of each other, lighting devices 2a and 2b are within communications range of each other, and lighting devices 2b and 2c are within communications range of each other. The sensing range is thus generally larger than the communications range. The sensing range is the range within which an impending transmission may be detected, while the communications range is the range within which a transmission can be successfully decoded. In the line configuration of FIG. 1 the lighting device 2a is able to wirelessly communicate with the lighting device 2b and the lighting device 2b is able to wirelessly communicate also with the lighting device 2c. Assume that lighting device 2a intends to transmit a message s1(t) to lighting device 2c and that lighting device 2c intends to transmit a message s2(t) to lighting device 2a. According to the CSMA/CA (carrier sense multiple access with collision avoidance) protocol, a lighting device wishing to transmit a message first has to listen to the communications channel for a predetermined amount of time to determine whether or not another lighting device is transmitting on the same communications channel within the sensing range. If the communications channel is sensed idle the lighting device is permitted to begin the transmission process. Hence, at stage i) (i.e. in the fiorst slot) in FIG. 1 the lighting device 2a transmits message s1(t) to lighting device 2b. If the communications channel is sensed as busy the lighting device defers its transmission for a random period of time. Once the transmission process begins, it is still possible for the actual transmission of application data to not occur. Collision avoidance is used to improve CSMA performance by not allowing wireless transmission of a lighting device if another lighting device is transmitting, thus reducing the probability of collision due to the use of a random truncated binary exponential backoff time. Hence, at stage i) in FIG. 1 the lighting device 2c cannot transmit message s2(t) since the communications channel is occupied by lighting device 2a. The CSMA/CA protocol thus requires four communication slots for messages s1(t) and s2(t) to be exchanged between lighting devices 2a and 2c; at stage i) lighting device 2a transmits message s1(t) to lighting device 2b; at stage ii) lighting device 2b transmits message s1(t) to lighting device 2c; at stage iii) lighting device 2c transmits message s2(t) to lighting device 2b; and at stage iv) lighting device 2b transmits message s2(t) to lighting device 2a.

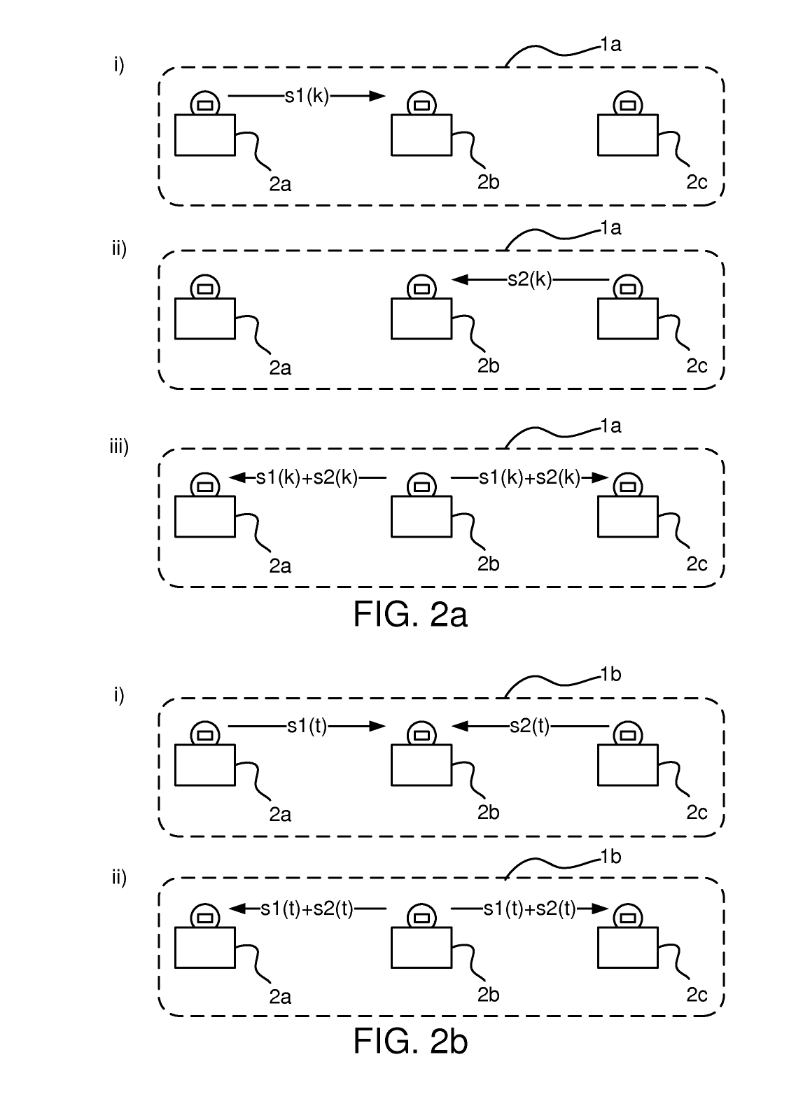

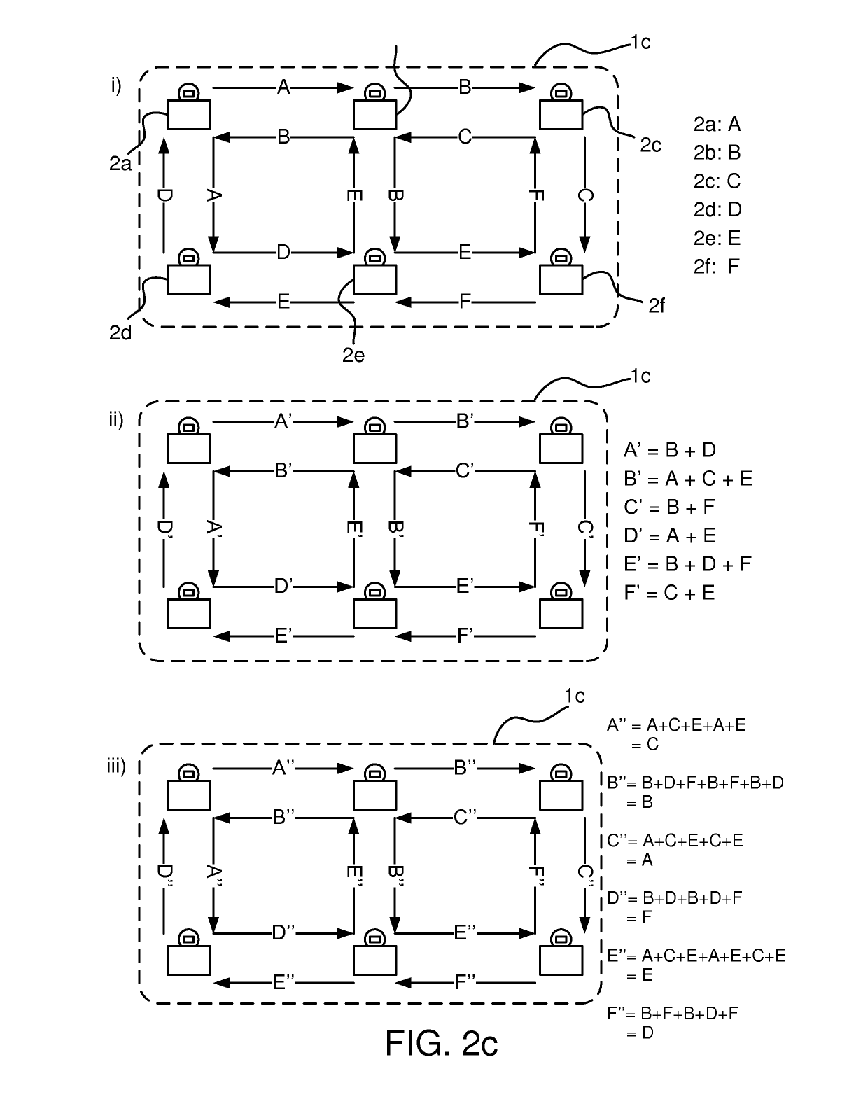

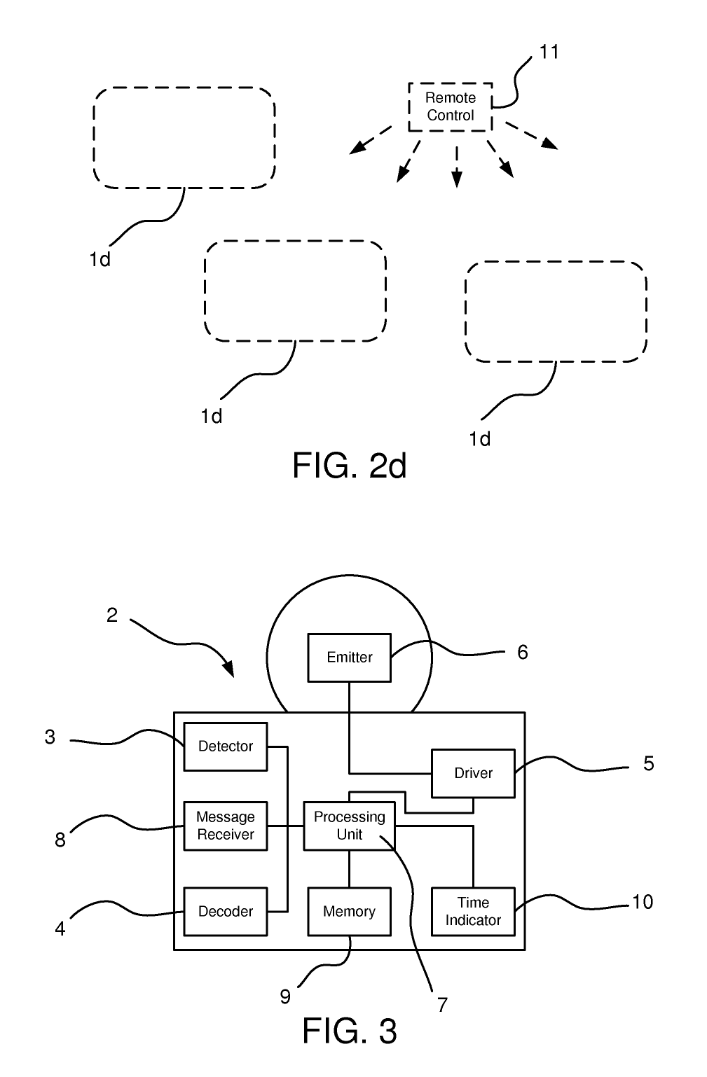

In general terms, there are two families of protocols proposed by the present invention. Hereinafter these protocols will be denoted as Protocol I and Protocol II, respectively. Also, the proposed protocols will be described by considering two lighting system topologies; a line configuration (as in FIGS. 2a-b) that is typical in corridors and a grid configuration (as in FIG. 2c) that would be typical in cellular and open offices.

Operation of the two proposed families of protocols will be described below with references to the lighting systems 1a, 1b, 1c and 1d of FIGS. 2a-2d, respectively. Before describing the two families of protocols in detail, a lighting device which may be advantageously used in the lighting systems 1a, 1b, 1c and 1d will be described.

FIG. 3 schematically illustrates in terms of functional blocks a lighting device 2, such as the lighting devices 2a, 2b, 2c, 2d, 2e and 2f of FIGS. 2a-2c. The lighting device 2 is configured to emit illumination light as well as coded light, wherein the coded light comprises a coded light message. The lighting device 2 comprises a light driver 5, a light emitter 6, a light detector 3 and a light decoder 4. At least part of the functionality of the light driver 5 and the light decoder 4 may be realized by a processing unit 7. The light driver 5 is arranged to form a coded light message to be transmitted to another lighting device. The light emitter 6 is associated with the illumination function of the light source 2 (i.e. for emitting the illumination light) and can be any suitable light source. For example, the light emitter 6 preferably comprises one or more LEDs, but it could as very well comprise one or more halogen, FL or HID sources, etc. The light emitter 6 is driven by the light driver 5. The light emitter 6 may thus from the light driver 5 receive a control signal relating to the light to be emitted. The light detector 3 is arranged to receive light emitted by at least one other light source and in the received light detect coded light. The light detector 3 may comprise a photosensor or photodetector or any other suitable sensor of light. For example, the light detector 3 may comprise a charge-coupled device (CCD), CMOS sensor, a photodiode (inter alia a reverse biased LED), a phototransistor, a photoresistor, or the like. The light decoder 4 is arranged to from the light detector receive a signal indicative of the detected light, such as its waveform and its intensity. The light decoder 4 is thereby arranged to decode the coded light message embedded in the received light.

The light source 2 may further comprise a message receiver 8 for receiving information, such as information relating to scheduling of transmission of outgoing coded light messages, and/or other parameters of the coded light to be emitted. The transmission and reception of the information may utilize one of a plurality of different communications means. For example, the message receiver 8 may be a receiver configured to receive coded light. The message receiver 8 may comprise an infrared interface for receiving infrared light. Alternatively the message receiver 8 may be a radio receiver (i.e. radio based) for receiving wirelessly transmitted information. Yet alternatively the message receiver 8 may comprise a connector for receiving information transmitted by wire. The wire may be a powerline cable. The wire may be a computer cable.

The lighting device 2 may further comprise a memory 9. Information pertaining to the parameters of transmitted and/or received coded light messages and code parameters relating to the same may be stored in the memory 9.

The lighting device 2 may further comprise an internal time indicator 10. The internal time indicator 10 may be part of (or provided by) the processing unit 7. The internal time indicator 10 may furthermore be initialized by reception of a signal from a central time indicator, which may be comprised in the remote control unit 11 (as in FIG. 2d). This may enable clock synchronization between individual light sources of the lighting system.

Consider now the proposed lighting 1a system according to FIG. 2a operating according to the proposed Protocol I. The lighting system 1a includes three lighting devices 2a, 2b, 2c. The lighting devices 2a, 2b, 2c are within sensing range of each other, lighting devices 2a and 2b are within communications range of each other, and lighting devices 2b and 2c are within communications range of each other. According to Protocol I, the first two communications slots remain the same as communications slots i) and iii) in the conventional CSMA/CA protocol. To emphasize the digital nature of this protocol, the symbol k is used to represent time.

At stage i) lighting device 2a transmits, in a step S02a, a first coded light message s1(k) to lighting device 2b. In order to do so the light driver 5 of the lighting device 2a generates a coded light message s1(k) and instructs the light emitter 6 of the lighting device 2a to emit coded light comprising the coded light message s1(k). The coded light message s1(k) is received, in a step S04a, as light by the light detector 3 of the lighting device 2b which passes the received light to the light decoder 4 of the lighting device 2b to decode the coded light message s1(k). The light decoder 4 of the lighting device 2b is thereby arranged to, in a step S06a, identify at least a first incoming coded light message embedded in the received light. In view of the lighting device 2b, the lighting device 2a may be regarded as a first external lighting device.

At stage ii) lighting device 2c, in a step S02b, transmits a second coded light message s2(k) to lighting device 2b. The light driver 5 of the lighting device 2c generates a coded light message s2(k) and instructs the light emitter 6 of the lighting device 2c to emit coded light comprising the coded light message s2(k). The coded light message s2(k) is received, in a step S04b, as light by the light detector 3 of the lighting device 2b which passes the received light to the light decoder 4 of the lighting device 2b to decode the coded light message s2(k). The light decoder 4 of the lighting device 2b is thereby arranged to, in a step S06b, identify at least a second incoming coded light message embedded in the received light. In view of the lighting device 2b, the lighting device 2c may be regarded as a second external lighting device. Upon decoding of message s1(k) and message s2(k), the light driver 5 of the lighting device 2b, in a step S08, forms a new message s1(k)+s2(k) being a combination of the message s1(k) and message s2(k) as an outgoing coded light message. The light decoder 4 may first decode the first incoming coded light message s1(k) and the second incoming coded light message s2(k) from the received light and then re-encoded each one said the incoming coded light message and the second incoming coded light message (according to the so-called decode-and-forward principle which as such is known in the art). The outgoing coded light message is then formed from the re-encoded coded light messages. The combination may comprise adding a first waveform representing the first incoming coded light message s1(k) with a second waveform representing the second incoming coded light message s1(k). The first incoming coded light message s1(k) and the second incoming coded light message s2(k) may, for example, represent a first binary information sequence and a second binary information sequence, respectively. In such a binary context, i.e. the finite field having elements 0 and 1 where 0+0=0, 1+0=0+1=1 and where 1+1=0, the “+” may thus represent an XOR operation of the individual bits. The combination may thus comprise performing a bit-wise XOR operation between the first binary information sequence and the second binary information sequence. In general, the “+” operation may be defined over the finite field according to which the values of the coded light messages have been defined and/or encoded.

At stage iii) the light emitter 6 of the lighting device 2b, in a step S10, emits coded light comprising the outgoing coded light message. Advantageously the outgoing coded light message is transmitted as a omni-directional broadcast message. Having previously stored message s1(k) as a priori information in its memory 9, the lighting device 2a is upon reception and detection of the s1(k)+s2(k) able to cancel the a priori component s1(k) to retrieve message s2(k). In more detail, a message having information components originating from at least two lighting devices (e.g. of the type s1(k)+s2(k)) is denoted a composite coded light message. In general, the lighting devices may receive more than one such composite coded light messages, see FIG. 2c. Thus, at least one of the first incoming coded light message and the second incoming coded light message may represents a first composite coded light message and a second composite coded light message, respectively. According to the lighting system 1a the lighting device 2a receives one composite coded light message s1(k)+s2(k) from the lighting device 2b. An individual coded light message in such a composite coded light message may be identified by comparing the composite coded light message with already known coded light message (in general, a first composite coded light message may be compared to a second composite coded light message). The already known (composite) coded light message may be stored in the memory 9. By comparing the composite coded light message s1(k)+s2(k) with the known and stored coded light message s1(k) the lighting device 2a is thus able to therein identify two individual coded light messages: s1(k) and s2(k). The comparison may comprises subtracting stored coded light message(s) from the first composite coded light message. Information representing the stored coded light message(s) may thereby be cancelled from the composite coded light message. Similarly, having previously stored message s2(k) as a priori information in its memory 9, the lighting device 2c is upon reception and detection of the s1(k)+s2(k) able to cancel the a priori component s2(k) to retrieve message s1(k). In comparison to the prior art system of FIG. 1 the network throughput is improved by 33% (instead of 2 messages exchanged over 4 slots, only 3 slots are needed to exchange 2 messages). As is apparent for the skilled person and as will be illustrated below, the lighting system 1a is not restricted only to have three lighting devices, but may be extended to have a plurality of lighting devices.

Turning now to the proposed lighting 1b system according to FIG. 2b which operates according to the proposed Protocol II. The lighting system 1b includes three lighting devices 2a, 2b, 2c. The lighting devices 2a, 2b, 2c are within sensing range of each other, lighting devices 2a and 2b are within communications range of each other, and lighting devices 2b and 2c are within communications range of each other. To emphasize the analog nature of this protocol, the symbol t is used to represent time. According to Protocol II, lighting device 2a and lighting device 2b are allowed to transmit concurrently, albeit not necessarily synchronously.

Thus, at stage i) lighting device 2a transmits, in a step S02a, a first coded light message s1(t) to lighting device 2b and lighting device 2c, in a step S02b, transmits a second coded light message s2(t) to lighting device 2b. The lighting device 2b may be required to receive light over the duration of the transmission of s1(t)+s2(t). Upon reception of the first coded light message s1(t) and the second coded light message s2(t) the lighting device 2b forms the outgoing message s1(t)+s2(t). However, since the first coded light message s1(t) and the second coded light message s2(t) may be transmitted at the same time, the lighting device 2b may, in a step S04, receive s1(t) and s2(2) as a superimposed message, i.e. s1(t)+s2(t). The first coded light message s1(t) and the second coded light message s1(t) may thus, in a step S06, in the received coded light be identified as a common superimposed message. The outgoing message s1(t)+s2(t) is then transmitted by means of emitted coded light from the lighting device 2b in a second time slot, i.e. at stage ii) according the above, i.e. by forming, in a step S08, an outgoing coded light message by the light driver 5 and by emitting, in a step S10, coded light comprising the outgoing message by the light emitter 6. The outgoing coded light message may be an amplification of the received light (according to the so-called amplify-and-forward principle which as such is known in the art). Subsequent to receiving the outgoing message s1(t)+s2(t), the lighting device 2a cancels the a priori known analog component s1(t) to retrieve message s2(t). Similarly, the lighting device 2c cancels the a priori known analog component s2(t) to retrieve message s1(t). In comparison to the prior art system of FIG. 1 the network throughput is improved by 50% (instead of 2 messages exchanged over 4 slots, only 2 slots are needed to exchange 2 messages). As is apparent for the skilled person and as will be illustrated below, the lighting system 1b is not restricted only to have three lighting devices 2a, 2b, 2c, but may be extended to have a plurality of lighting devices.

Certain conditions may be required in order for Protocol II to work. For example, the lighting devices may be required to have access to information regarding which lighting devices in the lighting system that can concurrently emit coded light messages. The lighting device may furthermore be required to be able to coordinate concurrent illumination from two or more lighting devices (as lighting device 2b in the lighting system 1b of FIG. 2b). The lighting devices may furthermore be required to know whether or not to be in a broadcast mode. The lighting devices may furthermore be required to know which messages need to be decoded in a particular time slot. These aspects may be addressed as follows. When a lighting device has a message to transmit, it transmits a beacon message. The beacon message may comprise the address of the lighting device itself (i.e. a source address) and the address of at least one intended receiver (i.e. a destination address for at least one destination lighting device) for the message. Upon extraction of the destination address from the coded light message(s) an overhearing lighting device (i.e. lighting devices receiving the beacon message) may use this information to determine whether they can serve as coordinators of concurrent illumination. For example, each overhearing lighting device may check in a database of addresses whether the lighting device is able to communicate with the destination address or not. The database may be locally stored in the memory 9 or remotely accessible by the lighting device. If so, they send a concurrent transmission trigger beacon signaling by forming a response message comprising an acknowledgement thereof that concurrent illumination between certain pairs of lighting devices can occur. The lighting device having transmitted the beacon message may transmits its coded light message exclusively in response to having received the transmission trigger beacon signal within a predetermined amount of time from transmission of the beacon message. The response message may be formed only in case the lighting device is able to communicate with the destination address. Such a lighting device then transmits coded light messages in the next slot (and store the transmitted message). The coordinator lighting device(s) receive the concurrent illumination in this slot. In the subsequent slot, the intermediate coordinator lighting devices forward the superposed message, while the lighting device(s) receiving the superposed message is able to decode the superposed message from the received coded light by first cancelling out the stored transmitted message component.

FIG. 2c illustrates a lighting system 1c which operates according to the proposed Protocol II. However, as the skilled person understands, the lighting system 1c could also operate according to the proposed Protocol I. The lighting system 1c comprises six lighting devices 2a, 2b, 2c, 2d, 2e, and 2f, respectively. The lighting devices 2a, 2b, 2c, 2d, 2e, and 2f are arranged in a grid configuration. In the lighting system 1c, the lighting devices 2a, 2b, 2c, 2d, 2e and 2f are associated with coded light messages A, B, C, D, E and F, respectively, which are to be transmitted to all other lighting devices 2a, 2b, 2c, 2d, 2e and 2f in the lighting system 1c. As the skilled person understands, each coded light messages A, B, C, D, E and F, respectively, could be associated with one or more specific lighting devices intended to receive one or more specific coded light messages of the coded light messages A, B, C, D, E and F. It is further assumed that lighting devices 2a, 2b, 2c, 2d, 2e and 2f are within sensing range of each other and that each lighting devices 2a, 2b, 2c, 2d, 2e and 2f only is within communication range with its nearest vertical and/or horizontal neighbor. That is, lighting devices 2a is only within communication range with lighting devices 2b and lighting devices 2d; lighting devices 2b is only within communication range with lighting devices 2a, lighting devices 2c and lighting devices 2e, etc.

Under Protocol II, in the first time slot, i.e. at stage i), each lighting devices 2a, 2b, 2c, 2d, 2e and 2f concurrently broadcasts the message (A, B, C, D, E and F) that it needs to send to its neighboring lighting devices 2a, 2b, 2c, 2d, 2e and 2f and stores its own message in the memory 9. A neighboring lighting devices 2a, 2b, 2c, 2d, 2e and 2f listens to the overlapping message; for example, lighting devices 2a has received concurrent messages B (from lighting device 2b) and D (from lighting device 2d) in the first time slot, and hence received the superimposed message B+D. Likewise, lighting devices 2b has received concurrent messages A (from lighting device 2a), C (from lighting device 2c) and E (from lighting device 2e) in the first time slot, and hence received the superimposed message A+C+E. The light decoder 4 may thus further be arranged to, in the received coded light, identify also a third incoming coded light message embedded in the received light, where the third coded light message originates from a third external lighting device.

In the second time slot, i.e. at stage ii), each lighting device 2a, 2b, 2c, 2d, 2e and 2f broadcasts the superimposed message received at the first time slot; for example, lighting device 2a broadcasts message A′=B+D, while it receives a combination of message B′=A+C+E (originating from lighting device 2b) and message D′=A+E (originating from lighting device 2d). In the second time slot, i.e. at stage ii), lighting device 2b broadcasts message B′=A+C+E. The light driver 5 may thus further be arranged to include also a third incoming coded light message in the outgoing coded light message. For lighting systems where a lighting device receives two or more copies of the same message from two or more different lighting devices, the two or more copies may be combined for diversity gains.

In the third time slot, i.e. at stage iii), each lighting device 2a, 2b, 2c, 2d, 2e and 2f broadcasts the superimposed message received at the second time slot (after cancellation of a priori known signal components); for example, lighting device 2a broadcasts message A″=A+C+E+A+E=C, while it receives a combination of message B″=B+D+F+B+F+B+D=B (originating from lighting device 2b) and message D″=B+D+B+D+F=F (originating from lighting device 2d).

Protocols I and II may be extended to arbitrary network configurations where lighting devices are arranged to decode information by storing a transmitted signal or overhearing a signal component so that it may be used to cancel out interfering signal components from a superposed signal to retrieve signal(s) of interest. Further, arbitrary network configurations may always be partitioned in to smaller configurations to obtain the line and grid configurations described earlier, and the communication and control protocol may be executed over these configurations. FIG. 2d illustrates such a lighting system comprising a number of partitioned lighting systems 1d, where each lighting system 1d may take the form of lighting systems 1a, 1b or 1c. The lighting system further comprises a remote control unit 11 arranged to communicate with individual lighting devices of the lighting systems 1d.

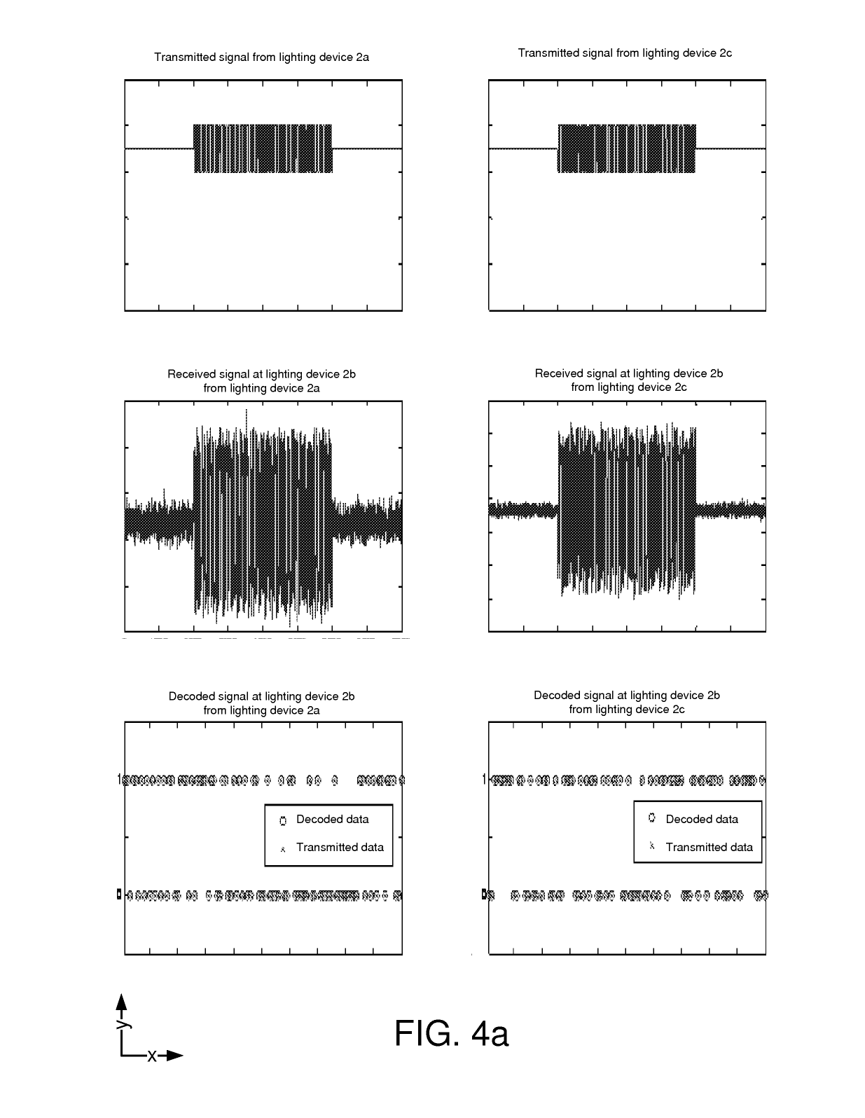

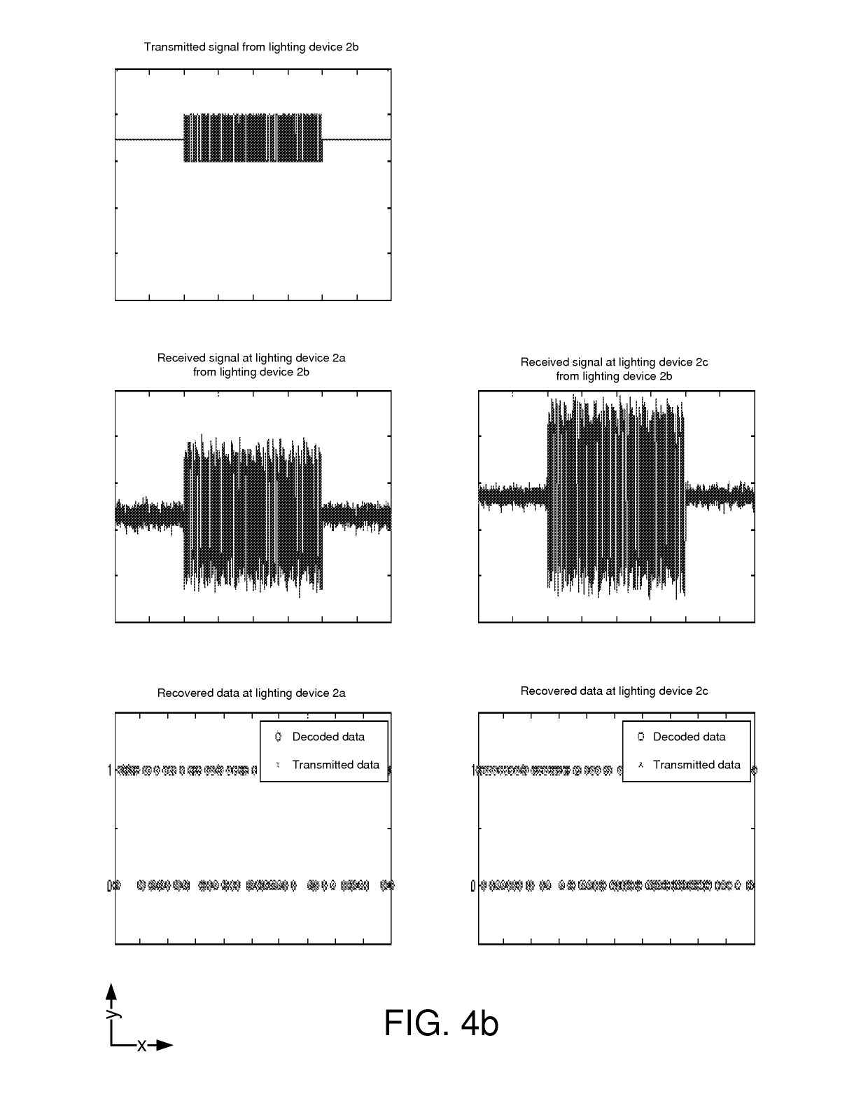

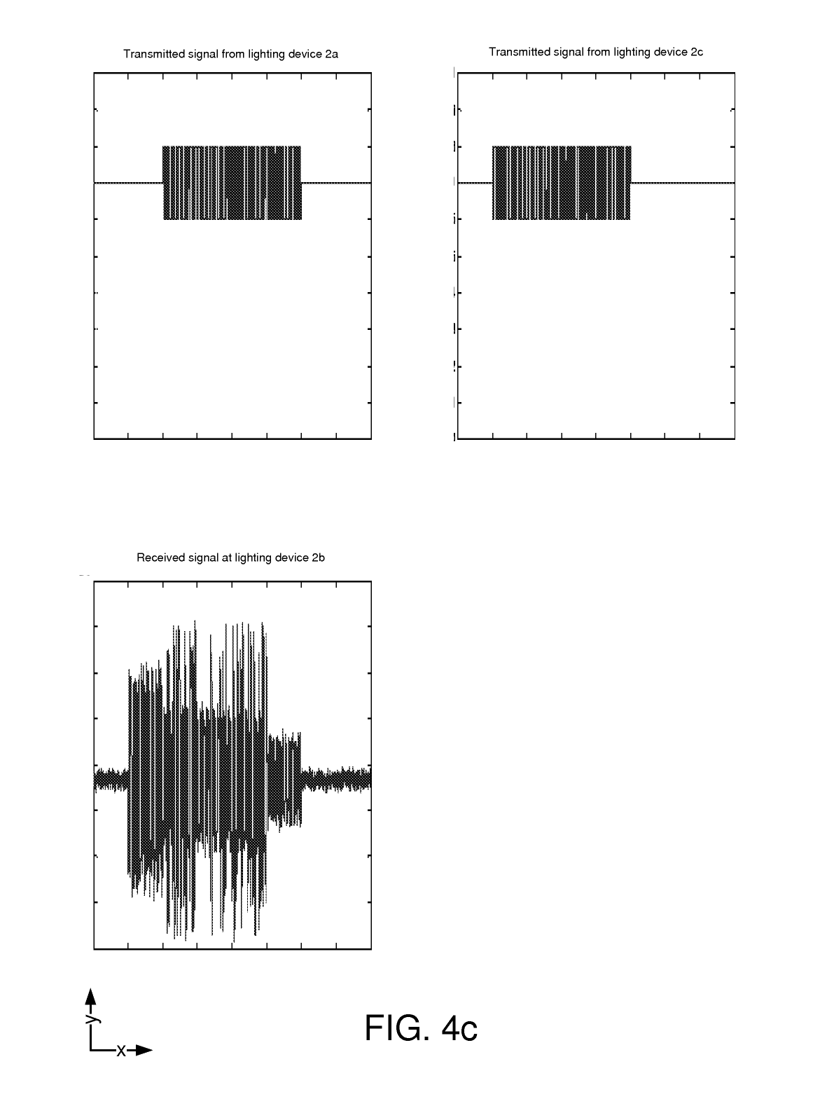

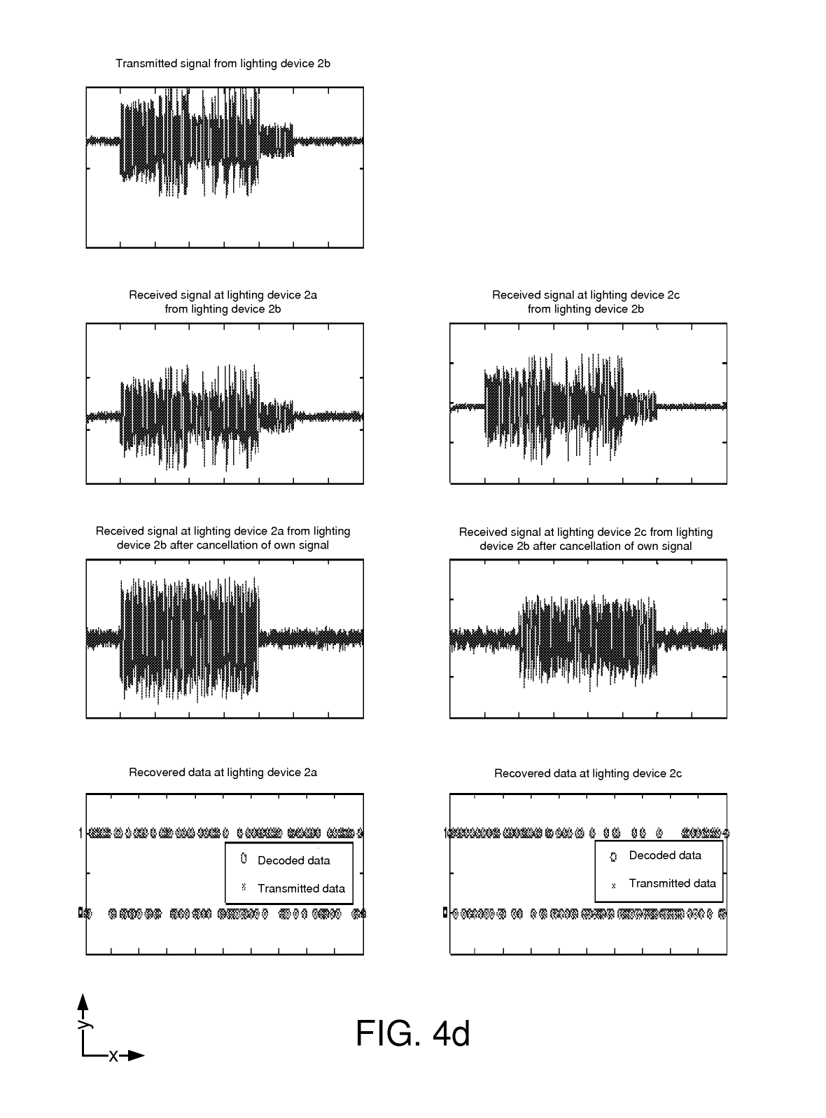

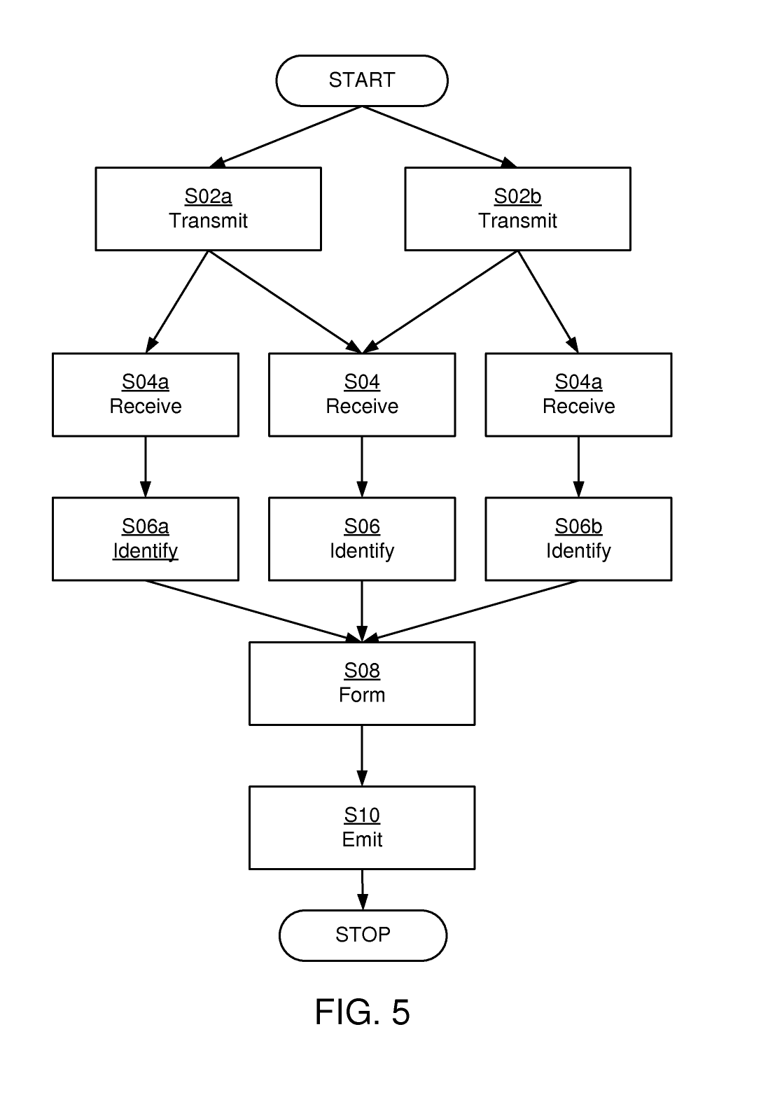

Protocols I and II have been validated using experimental results with three lighting devices in a line configuration (as the lighting systems 1a and 1b of FIGS. 2a and b). These results are illustrated in FIGS. 4a-d where for each graph the x-axis represents time and the y-axis represents amplitude.

In FIGS. 4a and b, results are shown for Protocol I. FIG. 4a shows the signal transmissions from lighting devices 2a and 2c of the lighting system 1a (top graphs), the received signals at lighting device 2b (middle graphs) and successful decoding at intermediate lighting device 2b in the lighting system 1a (bottom graphs). The circles and crosses in the bottom plot of FIG. 4a denote the transmitted data and decoded data bits and their correspondence indicates successful decoding. FIG. 4b shows the signal transmitted from lighting device 2b (top graph) and received at lighting devices 2a and 2c (middle graphs), and ultimately decoded there (bottom graphs). The correspondence between the circles and crosses in the bottom plots of FIG. 4b indicates successful decoding at lighting devices 2a and 2c.

In FIGS. 4c and 4d, results are shown for Protocol II. FIG. 4c shows the signal transmissions from source lighting devices 2a and 2c of the lighting system 1b (top graphs) and the analog superposed received signal at intermediate lighting device 2b in the lighting system 1b (bottom graph).

FIG. 4d shows the signal transmitted from lighting device 2b (top graph) and received at lighting devices 2a and 2c (next to top graphs), and ultimately decoded there (bottom graphs) after cancelling out the a priori known analog signal component (next to bottom graphs). The correspondence between the circles and crosses in the bottom plots of FIG. 4d indicates successful decoding at lighting devices 2a and 2c.

In summary, proposed herein is a lighting device, a lighting system and a method for communicating data between a first lighting device (2a) and a second lighting device (2c) via at least one third intermediate lighting device (2b). Such a method may be summarized as comprising
transmitting a first data signal s1(k) by the first lighting device (2a);
transmitting a second data signal s2(k) by the second lighting device (2c);
receiving the first and second data signals by the third intermediate lighting device (2b);
transmitting a combined data signal s1(k)+s2(k) by the third intermediate lighting device (2b);
receiving the combined data signal s1(k)+s2(k) by the first lighting device (2a) and canceling the a priori known first data signal s1(k) to obtain the second data signal s2(k); and
receiving the combined data signal s1(k)+s2(k) by the second lighting device (2c) and canceling the a priori known second data signal s2(k) to obtain the first data signal s1(k).

In an embodiment (as defined by Protocol II), the steps (i) and (ii) occur concurrently.

The invention has mainly been described above with reference to a few embodiments. The invention may in particular be applied to lighting control systems or visible light networking. However, as is readily appreciated by a person skilled in the art, other embodiments than the ones disclosed above are equally possible within the scope of the invention, as defined by the appended patent claims.

In a coded lighting system as herein described, a central lighting controller (such as the remote control unit 11 or one of the lighting devices 2a-f) can coordinate the ‘transmissions’, i.e. determine when and how the light output of lighting devices 2a-2f is modulated in accordance with the network coding protocol used. This is further facilitated by commissioning, an aspect common in lighting systems. Thus the role of each lighting device 2a-f can be specified and coordinated by the controller. This makes network coded light communications systems unique and very effective as well.

1. A lighting device for receiving and emitting coded light, comprising:
a light detector arranged to receive light and in said received light detect coded light;
a light decoder configured to identify, in said received coded light, at least a first incoming coded light message and a second incoming coded light message embedded in said received light, the first coded light message originating from a first external lighting device and the second coded light message originating from a second external lighting device;
a light driver arranged to form an outgoing coded light message, said outgoing coded light message being a combination of the first incoming coded light message and the second incoming coded light message; and
a light emitter arranged to emit coded light comprising said outgoing coded light message.

2. The lighting device according to claim 1, wherein each one of the first coded light message and the second coded light message comprises a beacon message, respectively, each beacon message comprising a source address and a destination address.

3. The lighting device according to claim 2, wherein said light decoder is further arranged to extract said destination address from each one of the first coded light message and the second coded light message, to check in a database of addresses whether the lighting device is able to communicate with the destination address or not, and to form a response message comprising an acknowledgement thereof only in case the lighting device is able to communicate with the destination address, and wherein the light emitter is further arranged to emit coded light comprising said response message.

4. The lighting device according to claim 1, further comprising a memory, wherein at least one of said first incoming coded light message and said second incoming coded light message represents a first composite coded light message and a second composite coded light message, respectively, and wherein said light decoder is arranged to in said at least one of said first composite coded light message and said second composite coded light message identify at least two individual coded light messages by comparing said at least one of said first composite coded light message and said second composite coded light message to at least one stored coded light message stored in said memory.

5. The lighting device according to claim 4, wherein said comparing comprises subtracting said at least one stored coded light message from said at least one of said first composite coded light message and said second composite coded light message so as to cancel information representing said at least one stored coded light message from said at least one of said first composite coded light message and said second composite coded light message.

6. The lighting device according to claim 4, wherein said at least one stored coded light message originates from at least one of said lighting device, said first external lighting device, and said second external lighting device.

7. The lighting device according to claim 1, wherein said combination comprises adding a first waveform representing said first incoming coded light message with a second waveform representing said second incoming coded light message.

8. The lighting device according to claim 1, wherein said first incoming coded light message and said second incoming coded light message represent a first and a second binary information sequence, respectively.

9. The lighting device according to claim 8, wherein said combination comprises performing a bit-wise XOR operation between said first and said second binary information sequence.

10. The lighting device according to claim 1, wherein said first coded light message and said second coded light message are transmitted using a CSMA/CA based protocol.

11. The lighting device according to claim 1, further comprising a message receiver, said message receiver being arranged to receive a message from a central control unit, said message relating to scheduling of transmission of said outgoing coded light message.

12. The lighting device according to claim 1, wherein said light decoder is further arranged to decode and then to re-encode each one said first incoming coded light message and said second incoming coded light message, and to form said outgoing coded light message therefrom.

13. The lighting device according to claim 1, wherein the light decoder is further arranged to, in said received coded light, identify a third incoming coded light message embedded in said received light, the third coded light message originating from a third external lighting device, and wherein said light driver is further arranged to include also said third incoming coded light message in said outgoing coded light message.

14. A coded light system comprising the lighting device according to claim 1, the first external lighting device and the second external lighting device.

15. A method for in a lighting device receiving and emitting coded light, comprising:
receiving, by a light detector of the lighting device, light and in said received light detect coded light;
identifying in said received coded light, by a light decoder of the lighting device, a first incoming coded light message and a second incoming coded light message embedded in said received light, the first coded light message originating from a first external lighting device and the second coded light message originating from a second external lighting device;
forming, by a light driver of the lighting device, an outgoing coded light message, said outgoing coded light message being a combination of the first incoming coded light message and the second incoming coded light message; and
emitting, by a light emitter of the lighting device, coded light comprising said outgoing coded light message.
